(19) United States
(12) Patent Application Publication
(10) Pub. No.: US 2025/0117798 A1
(43) Pub. Date: Apr. 10, 2025

(54) SYSTEM AND METHODS OF PROCESSING DATA FOR FRAUD DETECTION AND ANALYSIS

(71) Applicant: The Toronto-Dominion Bank, Toronto (CA)

(72) Inventors: Venkata Balasubramanyam MALISETTY, Welland (CA); Sajid PATHAN, Mississauga (CA)

(73) Assignee: The Toronto-Dominion Bank, Toronto (CA)

(21) Appl. No.: 18/481,460

(22) Filed: Oct. 5, 2023

(51) Int. Cl. G06Q 20/40; G06F 9/54

(52) U.S. Cl. CPC G06Q 20/4016; G06F 9/547

(57) ABSTRACT

A computer-implemented method is disclosed. The method includes: receiving, via a computing system, a message in connection with at least one transaction processed and flagged by the computing system as potentially being associated with a fraud status; creating a robotic process automation (RPA) software bot for collecting related data associated with the at least one flagged transaction; providing, by the RPA software bot using API calls, collected data to an application such that the data is actionable using the application; and updating a cloud-based database by creating a database record associated with the transaction responsive to determining that neither RPA nor manual tasks in connection with the transaction performed using the application raises a runtime exception.

### TECHNICAL FIELD

The present disclosure relates to data processing systems and, in particular, to a system and methods of processing data for fraud detection and analysis.

### BACKGROUND

Digital fraud detection agencies review incoming financial transactions that are flagged by a transaction monitoring entity (e.g., Fiserv) as potential fraud. Agents are tasked with reviewing fraud alerts and decisioning each alert as either fraud or not fraud. The reviewing process involves repetitive tasks and requires agents to access multiple application systems to verify data points. The data points captured by agents are not currently standardized with alerts that are manually allocated to agents. This does not allow for tracking of detailed process management insights such as average handle time (AHT) per agent, decisioning trends, etc., making it difficult for process owners to effect changes that can improve efficiency.

### BRIEF DESCRIPTION OF DRAWINGS

Reference will now be made, by way of example, to the accompanying drawings which show example embodiments of the present application and in which:

FIG. 1 is a schematic diagram illustrating an operating environment of an example embodiment of the present disclosure;

FIG. 2A is a high-level schematic diagram of an example computing device;

FIG. 2B shows a simplified organization of software components stored in memory of the example computing device of FIG. 2A;

FIG. 3 shows, in flowchart form, an example method for processing incoming transactions data that is flagged for fraud analysis;

FIG. 4 shows, in flowchart form, another example method for processing incoming transactions data that is flagged for fraud analysis; and

FIG. 5 shows, in flowchart form, an example method for processing agent decisioning results in connection with flagged transactions.

Like reference numerals are used in the drawings to denote like elements and features.

### DETAILED DESCRIPTION OF EXAMPLE EMBODIMENTS

In an aspect, the present disclosure describes a computing system. The computing system includes a processor and a memory coupled to the processor. The memory stores computer-executable instructions that, when executed by the processor, cause the processor to: receive, via a computing device, a message in connection with at least one transaction processed and flagged by the computing device as potentially being associated with a fraud status; create a robotic process automation (RPA) software bot for collecting related data associated with the at least one flagged transaction; receive, from the RPA software bot via calls of an application programming interface (API) associated with a cloud-based database, collected data to an application such that the data is actionable using the application; and update the database by creating a database record associated with the transaction responsive to determining that neither RPA nor manual tasks in connection with the transaction performed using the application raises a runtime exception.

In some implementations, the API calls may comprise calls of an API associated with the cloud-based database for invoking one or more create, read, update, or delete operations.

In some implementations, the application may comprise a canvas app created using a platform for creating low-code tools to automate processes in a software sandbox environment.

In some implementations, the database record may include information describing at least one task performed by an RPA software bot and at least one task performed manually by a human agent.

In some implementations, the application may provide a human agent with an option to claim a task associated with a flagged transaction.

In some implementations, the RPA software bot may be further configured to obtain data from the cloud-based database using API calls associated with the database.

In some implementations, the instructions, when executed, may further cause the processor to: receive, via the application, input of transaction identifier and a fraud status decision in connection with a transaction; and transmit, via calls of the API to the RPA software bot, a request to action an account associated with the transaction, the request including the transaction identifier and the fraud status decision.

In another aspect, a computer-implemented method is disclosed. The method includes: receiving, via a computing system, a message in connection with at least one transaction processed and flagged by the computing system as potentially being associated with a fraud status; creating a robotic process automation (RPA) software bot for collecting related data associated with the at least one flagged transaction; providing, by the RPA software bot using calls of an application programming interface (API) associated with a cloud-based database, collected data to an application such that the data is actionable using the application; and updating the database by creating a database record associated with the transaction responsive to determining that neither RPA nor manual tasks in connection with the transaction performed using the application raises a runtime exception.

In yet another aspect, a non-transitory computer-readable storage medium is disclosed. The computer-readable storage medium contains computer-executable instructions thereon which, when executed by a processor, cause the processor to: receive, via a computing system, a message in connection with at least one transaction processed and flagged by the computing system as potentially being associated with a fraud status; create a robotic process automation (RPA) software bot for collecting related data associated with the at least one flagged transaction; receive, from the RPA software bot using calls of an application programming interface (API) associated with a cloud-based database, collected data to an application such that the data is actionable using the application; and update the database by creating a database record associated with the transaction responsive to determining that neither RPA nor manual tasks in connection with the transaction performed using the application raises a runtime exception.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

An automated case management system for fraud detection and analysis is proposed. The proposed system integrates use of robotic process automation (RPA) with an application development environment, such as Microsoft Power Platform (PP), to implement a solution for fraud alerts processing. An alert may be generated when a transaction monitoring entity determines that an account transaction, which may be a Zelle™, TransferNow™, or FundNow™ transaction, may be fraud. Alerts and collected data points associated with the transactions may be presented in an identity review app for fraud agents' manual review. Based on their review, agents can render a decision as to an alert's status as fraud or not fraud. An agent's decision may be shared via the identity review app, and trigger certain defined actions in connection with the alert based on a fraud type.

RPA is generally used for automating predictable and repetitive tasks. Where a data parameter requires human involvement (e.g., for validation or update), there may be significant risk of RPA runtime exceptions being raised. In such cases, a low-code (or no-code) identity review app solution may be optimal for facilitating simple work flows and linear tasks such as, for example, tracking and validating data entries. In particular, a custom identity review app developed on a low-code/no-code development platform may be useful for streamlining, managing, and tracking manual fraud review work flows.

A digital fraud detection agency receives a list of transactions that are flagged by a transaction-monitoring entity (e.g., Fiserv) as potential fraud, based on pre-defined rules. The transactions data is extracted and assigned to agents for them to begin their review process. More particularly, the transaction-monitoring entity may forward the transactions data in a message (e.g., email) to a digital worker's (i.e., an RPA software bot) inbox. The digital worker may be configured to extract the transactions data from the message and populate a work queue using the extracted data.

The proposed design of the present application allows RPA software bots to obtain information from and/or update data records of a cloud-based database (e.g., Microsoft Dataverse™) such that human involvement may be seamlessly integrated with RPA processes as part of a fraud detection and analysis system. An automated digital worker may access, or log into, multiple application systems in order to gather evidence data associated with flagged transactions. The evidence data may comprise, among others, user and/or account information, transaction history, etc. For example, evidence data may be retrieved from one or more of: Compass™ Fidelity™, TLO™, ThreatMetrix™, Relationship Manager™, and the like.

The collected evidence may be presented, by a digital worker, in a user interface of an identity review app. In some implementations, the identity review app may be a custom low-code/no-code application developed using Microsoft Power Apps suite of services. For example, a canvas app (such as one which may be developed on Microsoft Dynamics 365 platform) may provide a UI-based portal that allows agents to access and review transaction evidence data. A cloud-based database, such as Microsoft Dataverse™, allows data to be integrated from multiple sources into a single store, which can then be used in an identity review app. An RPA software bot may interact with one or more tables of the database by performing various CRUD (create, read, update, delete) operations. The operations may be performed using API calls to an API associated with the database. In this way, an identity review app that integrates both automated (i.e., RPA) and manual human components into a fraud decisioning process may be provided.

A fraud agent can log into an identity review app to review evidence that is presented on alert, and the agent can submit a decision (i.e., fraud or no fraud) to an RPA bot. The identity review app may present the collected data points as questions (e.g., binary questions, with “Yes” or “No” answers) to the agents through a user interface to decision to alert. The bot can complete next steps on the case, and the agent can be presented with the next case to work on.

Automating fraud alerts processing allows for standardizing data points captured in evidence gathering, replacing manual processes for allocating fraud alerts, and eliminating the need for agents to manually review data in multiple application systems. Further, alerts automation may facilitate eliminating the need for keeping multiple copies of data points and securing the collected data in accordance with enterprise standards.

In accordance with example embodiments of the present disclosure, fraud alerts, along with collected data points, can be presented in identity review apps for agent review. Based on evidence data gathered by digital workers, an agent can determine each alert's status as fraud or not. The agent's decision is shared (e.g., via the identity review app) with automation tools, such as RPA bots (or other digital workers), which may, in turn, be caused to complete actions for the alert depending on the determined fraud type. Team managers can collect detailed insights and analytics, including fraud alerts, average handle time, and decisioning trends.

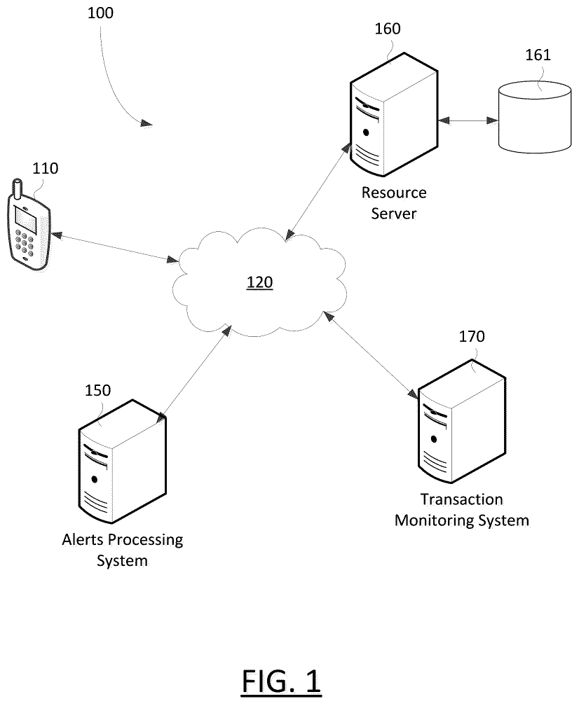

FIG. 1 is a schematic diagram illustrating an operating environment of an example embodiment. In particular, FIG. 1 illustrates exemplary components of a system 100 for fraud detection. As a specific example, the system 100 of FIG. 1 may be implemented to facilitate processing of fraud alerts associated with financial transactions that are flagged for fraud analysis.

As illustrated, a resource server 160 (which may also be referred to as a server computer system) and client devices 110 communicate via the network 120. The client device 110 is a computing device that may be associated with an entity, such as a user or client, having resources associated with the resource server 160. The client device 110 may take a variety of forms including, for example, a mobile communication device such as a smartphone, a tablet computer, a wearable computer such as a head-mounted display or smartwatch, a laptop or desktop computer, or a computing device of another type.

The resource server 160 may track, manage, and maintain resources, make lending decisions, and/or lend resources to the entity. The resources may, for example, be computing resources, such as memory or processor cycles. By way of further example, the resources may include stored value, such as fiat currency, which may be represented in a database. For example, the resource server 160 may be coupled to a database 161, which may be provided in secure storage. The secure storage may be provided internally within the resource server 160 or externally. The secure storage may, for example, be provided remotely from the resource server 160. For example, the secure storage may include one or more data centers. The data centers may, for example, store data with bank-grade security.

The database 161 may include data records for a plurality of accounts and at least some of the data records may define a quantity of resources associated with an entity. For example, the entity that is associated with the client device 110 may be associated with an account having one or more data records in the database. The data records may reflect a quantity of stored resources that are associated with the entity. Such resources may include owned resources and, in at least some implementations, borrowed resources (e.g., resources available on credit). The quantity of resources that are available to or associated with an entity may be reflected by a balance defined in an associated data record such as, for example, a bank balance.

The resource server 160 may be, in some implementations, a financial institution server that is operated by a financial institution, and the entity may be a customer of the financial institution.

The alerts processing system 150 can be configured to perform various operations for processing fraud alerts in connection with financial transactions. A fraud alert may, in some implementations, comprise a notification of an account transaction that is flagged as a potential fraud concern (e.g., use of stolen credit card data for unauthorized purchases). The alerts processing system 150 can receive fraud alerts, facilitate collection of evidence data associated with the fraud alerts, and provide the evidence data to a fraud detection agency system for manual review. An agent of the fraud detection agency can then review the captured evidence and submit a decision as to the fraud status of an alert/transaction. The agent's decision may be one or more of: suspected account takeover (ATO) fraud; confirmed ATO fraud; suspected identity theft fraud; confirmed identity theft fraud; new account fraud (NAF); intentional fraud; suspected scam; or confirmed scam.

Additionally, the alerts processing system 150 can trigger, post-decision, certain defined actions for managing an account that is affected by a fraud alert. More particularly, the alerts processing system 150 may cause various actions to be automatically performed in connection with the affected account, depending on whether the alert is determined to be fraud or not fraud.

For example, if an alert is determined to be fraud, the associated transaction (identified by a transaction ID) may be cancelled, account suspended, and online banking and debit cards disabled for the account. If, on the other hand, the alert is determined to not be fraud, the associated transaction may be released from an “on-hold” state.

While the alerts processing system 150 is illustrated in FIG. 1 as being external to the resource server 160, it will be understood that the alerts processing system 150 may be integrated with the resource server 160, in some implementations. By way of example, the alerts processing system 150 may be implemented as a component, such as a software module, of the resource server 160. More generally, the functions of the alerts processing system 150 may be provided as part of account security services that are implemented by the resource server 160 for detecting and analyzing transaction fraud associated with accounts at the resource server 160.

The transaction monitoring system 170 is a computing system that is configured to monitor transactions, such as transfers, deposits, withdrawals, etc., associated with various accounts and/or users. The monitored transactions may be of various types, such as Zelle™, TransferNow™, or FundNow™ transaction. The monitoring process involves identifying patterns and trends that may indicate illegal activities (e.g., transaction fraud), and flagging transactions for further analysis and investigation. The transaction monitoring system 170 can detect anomalies and suspicious activities based on transaction data of transactions associated with user accounts (for example, accounts at the resource server 160). The transaction monitoring system 170 processes account transactions and generates fraud alerts when actual or potential transaction fraud activity is detected. The fraud alerts may be transmitted to the alerts processing system 150. Each fraud alert may relate to a single transaction, or it may relate to a list of multiple transactions.

As described above, each of the client device 110, the alerts processing system 150, the resource server 160, and the transaction monitoring system 170 may be computer systems. The client devices 110, the alerts processing system 150, the resource server 160, and the transaction monitoring system 170 may be in geographically disparate locations. Put differently, the client devices 110 may be located remotely from at least one of the alerts processing system 150, the resource server 160, or the transaction monitoring system 170.

The network 120 is a computer network. In some implementations, the network 120 may be an internetwork such as may be formed of one or more interconnected computer networks. For example, the network 120 may be or may include an Ethernet network, an asynchronous transfer mode (ATM) network, a wireless network, or the like.

In the example of FIG. 1, the resource server 160 may provide both data transfer processing (e.g., bill payment) and data holding (e.g., banking) functions. That is, the resource server 160 may be both a financial institution server and also a bill payment processing server. The resource server 160 may, in some implementations, be a proxy server, serving as an intermediary for requests of client devices 110 seeking resources from other servers.

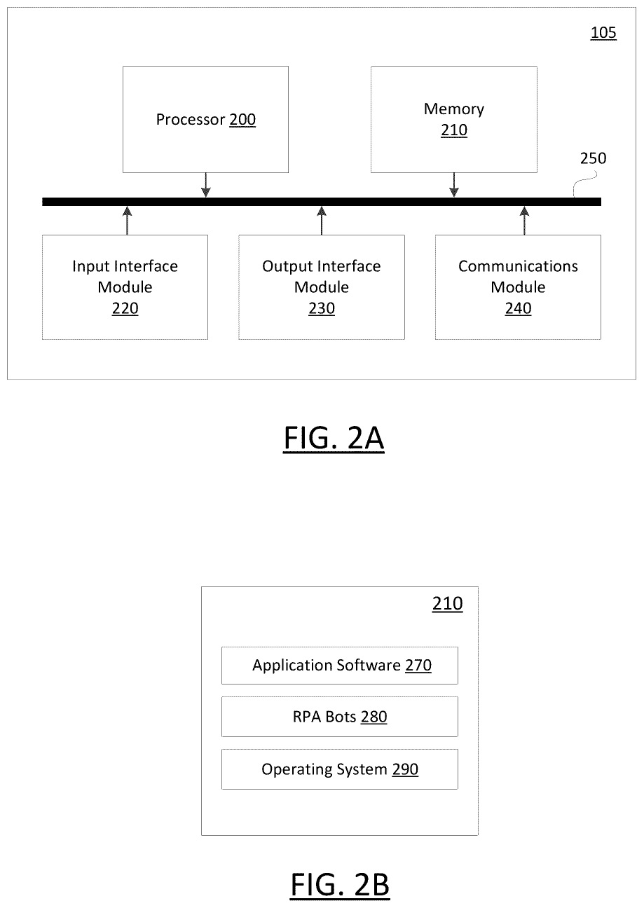

FIG. 2A is a high-level operation diagram of the example computing device 105. In at least some implementations, the example computing device 105 may be exemplary of one or more of the client devices 110, the alerts processing system 150, the resource server 160, or the transaction monitoring system 170. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some implementations, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some implementations, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components may include application software 270, robotic process automation (RPA) bot(s) 280, and an operating system 290.

The application software 270 adapts the example computing device 105, in combination with the operating system 290, to operate as a device performing particular functions. While a single application software 270 is illustrated in FIG. 2B, in operation, the memory 210 may include more than one application software 270 and different application software 270 may perform different operations.

In the example of FIG. 2B, the example computing device 105 includes one or more RPA bots 280, or software robots, that are executable by a processor (such as processor 200). The RPA bots 280 may be configured to perform various robotic tasks, based on instructions that are defined for the tasks and stored, for example, in the memory 210. An RPA bot 280 may be associated with one or more sub-bots or routines, which may also be stored in the memory 210. Upon completion of a robotic task, the RPA bots 280 may generate specific output(s) or otherwise notify a computing system that the task has been completed.

The operating system 290 is software. The operating system 290 allows the application software 270 and RPA bots 280 to access the processor 200, the memory 210, the input interface module 220, the output interface module 230 and the communications module 240. The operating system 290 may be, for example, Apple iOS™, Google™ 's Android™, Linux™, Microsoft™ Windows™, or the like.

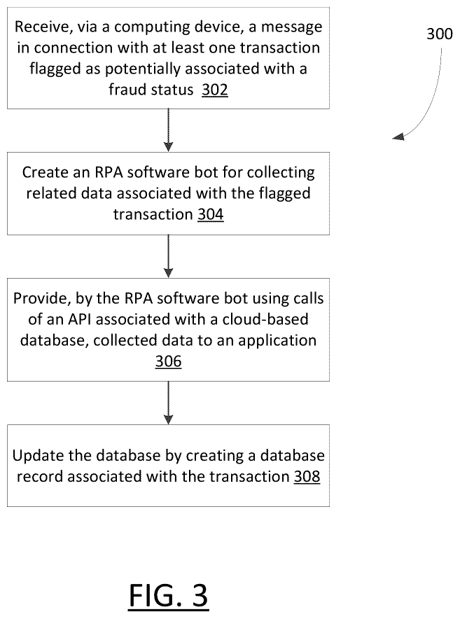

Reference is made to FIG. 3, which shows, in flowchart form, an example method 300 for processing incoming transactions data that is flagged for fraud analysis. A computing system may implement the method 300 (or parts thereof) as part of a process for handling fraud alerts and facilitating agent decisioning of flagged transactions. Operations 302 and onward are performed by one or more processors of a computing device such as, for example, the processor 200 (FIG. 2) of a suitably configured instance of the example computing device 105 (FIG. 2). The method 300 may be performed by, for example, a server that has access to transactions data of transactions associated with a plurality of user accounts, such as the alerts processing system 150.

An alerts processing system associated with a resource server may be configured to process transactions data of account transactions that are flagged for fraud analysis and investigation. More particularly, the alerts processing system may handle fraud alerts associated with a plurality of accounts at the resource server. A fraud alert may contain information about a suspected fraud transaction including, among others, a transaction identifier. In operation 302, the alerts processing system receives, via a computing device, a message in connection with at least one transaction that is processed and flagged by the computing device as potentially being associated with a fraud status. In at least some implementations, the computing device may comprise a system that monitors account transactions, such as the transaction monitoring system 170 of FIG. 1. Specifically, the computing device may be associated with a third-party entity that is authorized to access transactions data of transactions associated with the accounts at the resource server. The computing device may “flag” (or otherwise associate a fraud or potential fraud status with) a transaction, in response to determining that the transaction is not a legitimate transaction initiated by an authorized owner of the account.

The message may be in a suitable format for processing by the alerts processing system. In some implementations, the message may comprise an email transmitted by a transaction monitoring system, such as Fiserv. The message may contain transactions data for one or more transactions that have been flagged by the transaction monitoring system, in accordance with pre-defined rules. The transactions data may, for example, be provided in a text file format (e.g., CSV file) that is included in, attached to, or otherwise associated with, the message.

In operation 304, the alerts processing system creates one or more robotic process automation (RPA) software bots for collecting related data associated with the at least one flagged transaction. The RPA bots represent “digital workers” that are configured to gather relevant evidence data in connection with flagged transactions. In particular, the RPA bots perform operations for extracting transactions data from fraud alerts (and related messages) provided by a transaction monitoring system. The RPA bots are software components, or modules, that are associated with the alerts processing system. For example, the RPA bots may comprise software instructions that are stored in a memory associated with the alerts processing system.

In operation 306, the alerts processing system receives, from the RPA software bot, the collected evidence data associated with the at least one flagged transaction and provides said data to an application such that the data is actionable using the application. More particularly, the evidence data, such as user/account information and transaction history data, that is collected by the RPA software bot is transmitted to a queue manager for processing using a suitable application that is accessible by human agents.

The RPA software bot provides the evidence data to the application using calls of an application programming interface (API) associated with a cloud-based database. In some implementations, the API calls may comprise calls of an API associated with the cloud-based database for invoking one or more create, read, update, or delete (CRUD) operations. The application may, in some implementations, be an app created using a platform for creating low-code (or no-code) tools to automate processes in a software sandbox environment. By way of example, the application may be an identity review app that is configured to present, to human agents, evidence data that is collected by the RPA software to facilitate fraud alert decisioning by the agents. The identity review app may provide an agent with an option to claim a task associated with a flagged transaction. The agent may then review the evidence data and render a decision as to fraud status of the flagged transaction.

In operation 308, the alerts processing system updates the database by creating a database record associated with the transaction responsive to determining that neither RPA nor manual tasks in connection with the transaction performed using the application causes a runtime exception. A database record containing collected data points associated with the transaction is stored in a cloud-based database, provided that runtime exceptions are not raised by either the digital worker(s) or human agents' review using the application. In particular, the transaction details and evidence data gathered in connection with a flagged transaction may be stored in the cloud-based database. In some implementations, the database record may comprise information describing at least one task performed by an RPA software bot and at least one task performed manually by a human agent. For example, the database record may comprise an activity log in regard to actions performed by the RPA software bot and/or an agent reviewing the specific alert associated with the flagged transaction.

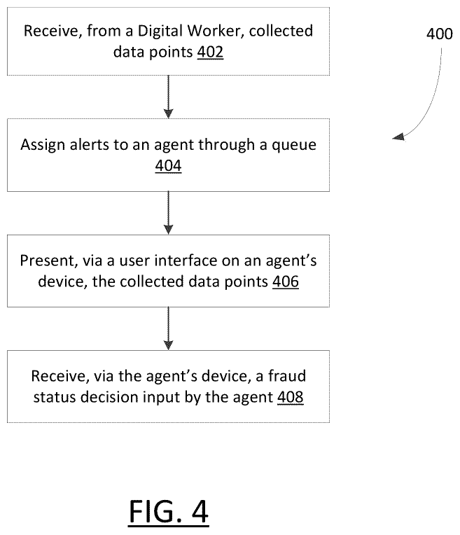

Reference is made to FIG. 4, which shows, in flowchart form, another example method 400 for processing incoming transactions data that is flagged for fraud analysis. A computing system may implement the method 400 (or parts thereof) as part of a process for handling fraud alerts and facilitating agent decisioning of flagged transactions. Operations 402 and onward are performed by one or more processors of a computing device such as, for example, the processor 200 (FIG. 2) of a suitably configured instance of the example computing device 105 (FIG. 2). The method 400 may be performed by, for example, a server that has access to transactions data of transactions associated with a plurality of user accounts, such as the alerts processing system 150. The operations of method 400 may be performed in addition to, or as alternatives of, one or more operations of method 300.

In operation 402, the alerts processing system receives, from a digital worker, collected data points in connection with a flagged transaction. The digital worker may, in some implementations, comprise RPA software bots that are configured to automatically collect evidence data associated with a flagged transaction from a plurality of application systems (e.g., Compass™, Fidelity™, TLO™, ThreatMetrix™, Relationship Manager™, etc.).

In operation 404, the alerts processing system assigns alerts to an agent through a queue manager. More particularly, the fraud alerts associated with one or more flagged transactions are assigned for review by human agents, using a work queue management system/tool. The work queue may be populated by first extracting transactions data from the fraud alerts and adding the transactions data to the queue.

The alerts processing system presents, via a user interface on an agent's device, the collected data points, in operation 406. The agent that is assigned a particular alert may access, using an application, such as an identity review app, relevant data associated with the alert reviewing task that is collected by the digital worker. The evidence data may include, among others, user/account information, transaction history data, and the like. The application may be an app that is developed on a low-code/no-code development environment, such as Microsoft Power Platform, and that provides a UI-based interface for the agent to access the evidence data.

In operation 408, the alerts processing system receives, via the agent's device, a fraud status decision that is input by the agent. The agent, upon manually reviewing the evidence data, renders a decision as to whether an alert corresponds to actual fraud. In some implementations, the agent may select, using a UI element (e.g., drop-down menu), an indication of the agent's decision. The selection may, for example, be one or more of: suspected account takeover (ATO) fraud; confirmed ATO fraud; suspected identity theft fraud; confirmed identity theft fraud; new account fraud (NAF); intentional fraud; suspected scam; or confirmed scam.

In response to receiving the fraud status decision, the alerts processing system may trigger certain automated tasks for actioning the account affected by the flagged transaction. For example, if the agent renders a suspected ATO fraud decision, the account may automatically be caused to be suspended, and online banking and debit cards for the account may be disabled temporarily.

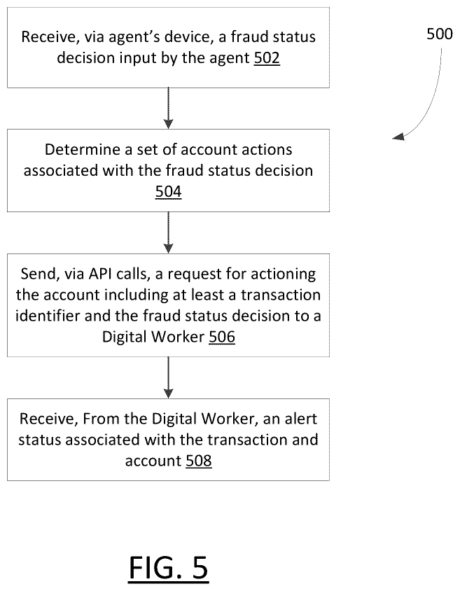

Reference is made to FIG. 5, which shows, in flowchart form, an example method 500 for processing agent decisioning results in connection with flagged transactions of user accounts. A computing system may implement the method 500 (or parts thereof) as part of a process for handling fraud alerts and facilitating agent decisioning of flagged transactions. Operations 502 and onward are performed by one or more processors of a computing device such as, for example, the processor 200 (FIG. 2) of a suitably configured instance of the example computing device 105 (FIG. 2). The method 500 may be performed by, for example, a server that has access to transactions data of transactions associated with a plurality of user accounts, such as the alerts processing system 150. The operations of method 500 may be performed in addition to, or as alternatives of, one or more operations of methods 300 and 400.

In operation 502, the alerts processing system receives, via an agent's device, a fraud status decision input by the agent. The fraud status decision is rendered by the agent upon manual review of evidence data, gathered by automated digital workers, relating to a transaction that has been flagged as fraud or potential fraud.

In operation 504, the alerts processing system determines a set of account actions associated with the fraud status decision. The account actions may include predefined actions that are set to be automatically triggered and which depend on the fraud status decision rendered by the reviewing agent. In some implementations, the alerts processing system may employ a mapping of fraud status decisions to account actions in determining which actions are required to be performed.

In operation 506, the alerts processing system sends, to a digital worker, a request for actioning the account pursuant to the fraud status decision. The request may be generated, for example, by the application (e.g., identity review app) that the agent uses as part of the manual review process. The request may indicate, at least, the fraud status decision, a transaction identifier, and a relationship identifier. The alerts processing system may use API calls to transmit the request to the digital worker. In particular, the request may be sent using API calls to an API associated with a cloud-based database, such as Microsoft Dataverse™.

In operation 508, the alerts processing system receives, from the digital worker, an alert status associated with the transaction and related account. The digital worker actions the account associated with the transaction in multiple application systems. The alert status is then shared by the digital worker to the application.

The digital worker's activities may be captured and shared to the application, enabling agency mangers to obtain detailed insights and analytics such as, among others, time spent by the digital worker on each alert, while gathering evidence and completing actioning of the alerts. The application may automatically capture the time taken by the agent to review the evidence data and to decision the alert. The analytics may be made available to the agency managers in real-time.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above.

In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor;
memory coupled to the processor, the memory storing computer-executable instructions that, when executed by the processor, cause the processor to:
receive, via a computing device, a message in connection with at least one transaction processed and flagged by the computing device as potentially being associated with a fraud status;
create a robotic process automation (RPA) software bot for collecting related data associated with the at least one flagged transaction;
receive, from the RPA software bot via calls of an application programming interface (API) associated with a cloud-based database, collected data to an application such that the data is actionable using the application; and
update the database by creating a database record associated with the transaction responsive to determining that neither RPA nor manual tasks in connection with the transaction performed using the application raises a runtime exception.

2. The computing system of claim 1, wherein the API calls comprise calls of an API associated with the cloud-based database for invoking one or more create, read, update, or delete operations.

3. The computing system of claim 1, wherein the application comprises a canvas app created using a platform for creating low-code tools to automate processes in a software sandbox environment.

4. The computing system of claim 1, wherein the database record comprises information describing at least one task performed by an RPA software bot and at least one task performed manually by a human agent.

5. The computing system of claim 1, wherein the application provides a human agent with an option to claim a task associated with a flagged transaction.

6. The computing system of claim 1, wherein the RPA software bot is further configured to obtain data from the cloud-based database using API calls associated with the database.

7. The computing system of claim 1, wherein the instructions, when executed, further cause the processor to:
receive, via the application, input of transaction identifier and a fraud status decision in connection with a transaction;
transmit, via calls of the API to the RPA software bot, a request to action an account associated with the transaction, the request including the transaction identifier and the fraud status decision.

8. A computer-implemented method, comprising:
receiving, via a computing device, a message in connection with at least one transaction processed and flagged by the computing device as potentially being associated with a fraud status;
creating a robotic process automation (RPA) software bot for collecting related data associated with the at least one flagged transaction;
providing, by the RPA software bot via calls of an application programming interface (API) associated with a cloud-based database, collected data to an application such that the data is actionable using the application; and
updating the database by creating a database record associated with the transaction responsive to determining that neither RPA nor manual tasks in connection with the transaction performed using the application raises a runtime exception.

9. The method of claim 8, wherein the API calls comprise calls of an API associated with the cloud-based database for invoking one or more create, read, update, or delete operations.

10. The method of claim 8, wherein the application comprises a canvas app created using a platform for creating low-code tools to automate processes in a software sandbox environment.

11. The method of claim 8, wherein the database record comprises information describing at least one task performed by an RPA software bot and at least one task performed manually by a human agent.

12. The method of claim 8, wherein the application provides a human agent with an option to claim a task associated with a flagged transaction.

13. The method of claim 8, wherein the RPA software bot is further configured to obtain data from the cloud-based database using API calls associated with the database.

14. The method of claim 8, further comprising:
receiving, via the application, input of transaction identifier and a fraud status decision in connection with a transaction;
transmitting, via calls of the API to the RPA software bot, a request to action an account associated with the transaction, the request including the transaction identifier and the fraud status decision.

15. A non-transitory, computer-readable medium storing computer-executable instructions that, when executed by a processor, cause the processor to:
receive, via a computing device, a message in connection with at least one transaction processed and flagged by the computing device as potentially being associated with a fraud status;
create a robotic process automation (RPA) software bot for collecting related data associated with the at least one flagged transaction;
receive, from the RPA software bot via calls of an application programming interface (API) associated with a cloud-based database, collected data to an application such that the data is actionable using the application; and
update the database by creating a database record associated with the transaction responsive to determining that neither RPA nor manual tasks in connection with the transaction performed using the application raises a runtime exception.

16. The computer-readable medium of claim 15, wherein the API calls comprise calls of an API associated with the cloud-based database for invoking one or more create, read, update, or delete operations.

17. The computer-readable medium of claim 15, wherein the application comprises a canvas app created using a platform for creating low-code tools to automate processes in a software sandbox environment.

18. The computer-readable medium of claim 15, wherein the database record comprises information describing at least one task performed by an RPA software bot and at least one task performed manually by a human agent.

19. The computer-readable medium of claim 15, wherein the application provides a human agent with an option to claim a task associated with a flagged transaction.

20. The computer-readable medium of claim 15, wherein the RPA software bot is further configured to obtain data from the cloud-based database using API calls associated with the database.
